(19) United States
(12) Patent Application Publication
(10) Pub. No.: US 2026/0349752 A1
(43) Pub. Date: Nov. 5, 2026

(54) COMPONENT LOADING METHOD AND APPARATUS, AND DEVICE AND STORAGE MEDIUM

(71) Applicant: BEIJING ZITIAO NETWORK TECHNOLOGY CO., LTD., Beijing (CN)

(72) Inventor: Ziyao LIAO, Beijing (CN)

(21) Appl. No.: 19/488,556

(22) PCT Filed: May 29, 2024
(86) PCT No.: PCT/CN2024/096181

§ 371 Date: Nov. 26, 2025

(30) Foreign Application Priority Data
May 31, 2023 (CN) 202310637190.7

(51) Int. Cl. G06F 9/445

(52) U.S. Cl. CPC G06F 9/44521

(57) ABSTRACT

A component loading method, apparatus, and device, and a storage medium are provided. The method includes: when receiving a component loading request for a target scenario, first obtaining component configuration information corresponding to the target scenario, where the component configuration information includes a correspondence between a first component and a scenario running node that correspond to the target scenario, and different scenario running nodes have an execution sequence relationship; upon entering the first scenario running node in the target scenario, loading the first component corresponding to a first scenario running node based on the component configuration information; and configuring the correspondence between the first component and the scenario running node by using the component configuration information, to implement configurable loading for a component loading sequence. Because the component loading sequence can be adjusted by updating the component configuration information, code of an application does not need to be adjusted, thereby facilitating adjustment of the component loading sequence and the like.

The present application claims priority to Chinese Patent Application No. 202310637190.7, filed with the China National Intellectual Property Administration on May 31, 2023 and entitled “COMPONENT LOADING METHOD AND APPARATUS, AND DEVICE AND STORAGE MEDIUM”, which is incorporated herein by reference in its entirety.

### FIELD

The present disclosure relates to the field of data processing, and in particular, to a component loading method, apparatus, and device, and a storage medium.

### BACKGROUND

With continuous development of computer technologies, functions, playing methods, and the like of an application are increasingly diversified, and at the same time, a quantity of components that need to be loaded for execution of the application is also increasing. The component is the smallest unit used to implement a specific function. For example, a large quantity of different components usually needs to be loaded during the entrance process of a live streaming room in the live streaming field.

Currently, logic for loading the component is coupled to code of the application. If it is desired to remove loading of some components, adjust a loading sequence between some components, or the like, the code of the application needs to be adjusted, which involves a large workload, and operations such as republishing the application need to be performed, which is costly.

Therefore, how to implement component loading to facilitate adjustment of a loading sequence and the like of components is a technical problem that needs to be urgently resolved currently.

### SUMMARY

To resolve the foregoing technical problem, the embodiments of the present disclosure provide a component loading method.

According to a first aspect, the present disclosure provides a component loading method. The method includes:
obtaining component configuration information corresponding to a target scenario in response to a component loading request for the target scenario, where the component configuration information includes a correspondence between a first component and a scenario running node in the target scenario, the scenario running node is obtained by dividing a life cycle of the target scenario, and different scenario running nodes have an execution sequence relationship; and
upon entering the first scenario running node in the target scenario, loading the first component corresponding to a first scenario running node based on the component configuration information.

In an optional implementation, upon entering the first scenario running node, the method further includes:
loading a second component corresponding to the first scenario running node based on a component original correspondence corresponding to the target scenario and the component configuration information.

In an optional implementation, loading the second component corresponding to the first scenario running node based on the component original correspondence corresponding to the target scenario and the component configuration information includes:
determining an original component to be loaded that corresponds to the first scenario running node based on the component original correspondence corresponding to the target scenario;
determining the second component corresponding to the first scenario running node based on the component to be loaded that corresponds to the first scenario running node and the first component corresponding to the target scenario; and
loading the second component corresponding to the first scenario running node.

In an optional implementation, before loading the second component corresponding to the first scenario running node, the method further includes:
in the case that the first scenario running node corresponds to a plurality of second components, determining a loading sequence between the plurality of second components based on a component loading sequence in the component original correspondence.

In an optional implementation, loading the first component corresponding to the first scenario running node based on the component configuration information includes:
determining a loading sequence between first components based on a component loading sequence in the component configuration information; and
loading the first component corresponding to the first scenario running node based on the loading sequence between the first components.

In an optional implementation, a priority of the loading sequence between the first components corresponding to the first scenario running node is higher than that of the second component corresponding to the first scenario running node.

In an optional implementation, the method further includes:
writing, based on a loading sequence between the first component and the second component that correspond to the first scenario running node, the first component and the second component that correspond to the first scenario running node into a preset queue sequentially, where the preset queue is used to load the first component and the second component.

In an optional implementation, upon entering the first scenario running node in the target scenario, loading the first component corresponding to the first scenario running node based on the component configuration information includes:
upon entering the first scenario running node in the target scenario, determining whether a component loading occasion is currently met, where the component loading occasion is determined based on a current system performance status and/or current frame rendering time-consuming information; and
when determining that the component loading occasion is currently met, reading and loading, from the preset queue, the first component corresponding to the first scenario running node.

In an optional implementation, the component configuration information further includes a correspondence between the first component and a component group, a loading sequence between different component groups corresponding to a same scenario running node, and a loading sequence between different first components corresponding to a same component group, where the correspondence between the first component and the component group is determined based on a rendering occasion feature of the first component; and upon entering the first scenario running node in the target scenario, loading the first component corresponding to the first scenario running node based on the component configuration information includes:
upon entering the first scenario running node in the target scenario, determining a component group corresponding to the first scenario running node based on the component configuration information; and
loading a first component corresponding to the component group.

In an optional implementation, before obtaining the component configuration information corresponding to the target scenario in response to the component loading request for the target scenario, the method further includes:
obtaining a delta component configuration file from a configuration platform; and
updating a full-scale component configuration file by using the delta component configuration file, to obtain an updated component configuration file, where the updated component configuration file includes the component configuration information corresponding to the target scenario.

In an optional implementation, the delta component configuration file includes editing operation information for a target component, and updating the full-scale component configuration file by using the delta component configuration file, to obtain the updated component configuration file includes:
performing an editing operation on configuration information of the target component in the full-scale component configuration file based on the editing operation information for the target component, to obtain updated configuration information of the target component; and
determining an updated component configuration file based on the updated configuration information of the target component.

According to a second aspect, the present disclosure provides a component loading apparatus. The apparatus includes:
a first obtaining module configured to obtain component configuration information corresponding to a target scenario in response to a component loading request for the target scenario, where the component configuration information includes a correspondence between a first component and a scenario running node in the target scenario, the scenario running node is obtained by dividing a life cycle of the target scenario, and different scenario running nodes have an execution sequence relationship; and
a first loading module configured to, upon entering the first scenario running node in the target scenario, load the first component corresponding to a first scenario running node based on the component configuration information.

According to a third aspect, the present disclosure provides a computer-readable storage medium having instructions stored thereon, where the instructions, when executed on a terminal device, cause the terminal device to implement the method described above.

According to a fourth aspect, the present disclosure provides a component loading device. The device includes: a memory, a processor, and a computer program that is stored in the memory and that is executable on the processor, where the processor, when executing the computer program, implements the method described above.

According to a fifth aspect, the present disclosure provides a computer program product. The computer program product includes a computer program or instructions, and the computer program or instructions, when executed by a processor, cause the method described above to be implemented.

### BRIEF DESCRIPTION OF THE DRAWINGS

The accompanying drawings herein, which are incorporated into and form a part of the description, illustrate the embodiments in line with the present disclosure and are used in conjunction with the description to explain the principles of the present disclosure.

To more clearly describe the technical solutions in the embodiments of the present disclosure or in the prior art, the accompanying drawings for describing the embodiments or the prior art are briefly described below. Apparently, those of ordinary skill in the art may still derive other drawings from these accompanying drawings without creative efforts.

FIG. 1 is a flowchart illustrating a component loading method according to an embodiment of the present disclosure;

FIG. 2 is a schematic diagram illustrating a storage structure of a component configuration file according to an embodiment of the present disclosure;

FIG. 3 is a schematic diagram illustrating an effect of a component loading method according to an embodiment of the present disclosure;

FIG. 4 is a schematic structural diagram illustrating a component loading apparatus according to an embodiment of the present disclosure; and

FIG. 5 is a schematic structural diagram illustrating a component loading device according to an embodiment of the present disclosure.

### DETAILED DESCRIPTION OF EMBODIMENTS

For a clearer understanding of the above-mentioned objectives, features and advantages of the present disclosure, the solutions of the present disclosure will be further described below. It should be noted that the embodiments of the present disclosure and features in the embodiments may be combined with each other without conflict.

Many specific details are set forth in the following description to facilitate a full-scale understanding of the present disclosure. However, the present disclosure may also be implemented in other ways different from those described herein. Apparently, the embodiments in the description are only some rather than all of the embodiments of the present disclosure.

A component is the smallest unit used to implement a specific function. The component includes two main functionalities: one is a user interaction interface UI displayed by a service, and the other is logic of the service itself. Currently, the manner of loading and managing the component is simple, and logic for loading the component is implemented by using code of an application. If it is desired to remove loading of some components, adjust a loading sequence between some components, or the like, the code of the application needs to be adjusted, which involves a large workload, and operations such as republishing the application need to be performed, which is costly.

The live streaming field is used as an example. With rapid development of live streaming technologies, live streaming functions are also increasingly diversified. According to division of service scenarios, live streaming service scenarios may include a plurality of service scenarios such as showroom live streaming, e-commerce live streaming, program live streaming, and multi-streamer live streaming. In the multi-streamer live streaming scenario, a plurality of playing methods can also be subdivided, for example, PK and live KTV challenge, and functions are diversified. For the foregoing live streaming service scenario, a client needs to use one or more different components to support the live streaming service scenario. A common showroom live streaming scenario is used as an example. A viewer needs to load a large quantity of components during the entrance process of a live streaming room. However, there are some components that are not related to a current live streaming room type in these components. Because current component loading logic is coupled to code of an application, the loading of some components cannot be removed in a timely manner. Therefore, some unrelated components are also loaded during the entrance process of the live streaming room, and performance is wasted to some extent. As a result, the live streaming room entrance process is time-consuming, which affects live room entry experience of the viewer.

Therefore, the embodiments of the present disclosure provide a component loading method. A component that needs to be loaded in a target scenario is configured as required in component configuration information corresponding to the target scenario, to avoid a performance waste caused by loading an unrelated component in a component loading process, reduce a loading time of the component in the target scenario, and improve user experience.

In addition, in the component loading method provided in the embodiments of the present disclosure, a correspondence between a first component and a scenario running node is configured in the component configuration information corresponding to the target scenario, and a component loading sequence is determined, so that some components can be controlled to be preferentially loaded, thereby achieving management of the component loading sequence.

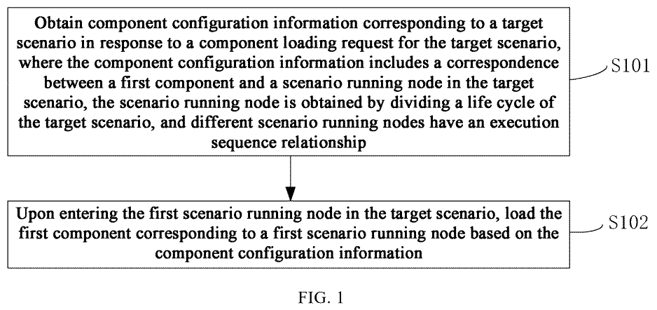

Based on this, an embodiment of the present disclosure provides a component loading method. FIG. 1 is a flowchart illustrating a component loading method according to an embodiment of the present disclosure. The method specifically includes the following steps.

S101: Obtain component configuration information corresponding to a target scenario in response to a component loading request for the target scenario.

The component configuration information includes a correspondence between a first component and a scenario running node in the target service scenario, the scenario running node is obtained by dividing the life cycle of the target scenario, and there is an execution sequence relationship between different scenario running nodes.

In this embodiment of the present disclosure, a configuration file is pulled from a configuration platform before a component is loaded. The configuration file is a file that stores the component configuration information based on a preset storage structure. Specifically, the configuration file stores a correspondence between the service scenario and the first component, and the correspondence is used to represent that the component corresponding to the service scenario is loaded in the corresponding service scenario.

In this embodiment of the present disclosure, when the component loading request for the target scenario is received, the component configuration information corresponding to the target scenario is first obtained from the configuration file. The component configuration information corresponding to the target scenario includes the correspondence between the first component and the scenario running node corresponding to the target scenario, and the correspondence is used to represent that the corresponding first component is loaded on the scenario running node corresponding to the first component.

The life cycle of the target service scenario may be divided into a plurality of scenario running nodes, and there is an execution sequence relationship between different scenario running nodes. Therefore, there is also a loading sequence relationship between first components having a correspondence with different scenario running nodes.

It should be noted that the first component in this embodiment of the present disclosure may be a component that needs to adjust the loading sequence in the target scenario, and the component that does not need to adjust the loading sequence may not be configured in the component configuration information.

To control, by using the component configuration information, a loading sequence relationship between different first components corresponding to a same scenario running node, in this embodiment of the present disclosure, the loading sequence relationship between the different first components corresponding to the same scenario running node may be further configured in the component configuration information.

In an optional implementation, priorities of the different first components corresponding to the same scenario running node may be separately set in the component configuration information. For example, priority attributes are configured for individual first components. The loading sequence relationship of the first components corresponding to the same scenario running node may be determined based on the priorities corresponding to the first components. For example, assuming that priorities of a component 1 and a component 2 that correspond to a same scenario running node are respectively set to 10 and 9, the component 1 whose priority is 10 is preferentially loaded relative to the component 2 whose priority is 9.

In another optional implementation, the first components corresponding to the same scenario running node may be classified into a same component group or different component groups. That is, a correspondence between the first component and the component group is configured in the component configuration information, and the correspondence is determined based on a rendering occasion feature of the first component. For example, if a component A needs to be rendered at a specific rendering occasion, the component A is added to a component group corresponding to the rendering occasion, that is, all components in the component group need to be loaded at the rendering occasion. In addition, a loading sequence relationship between different component groups corresponding to a same scenario running node and a loading sequence relationship between different first components corresponding to a same component group may be further configured in the component configuration information.

Specifically, a loading sequence between different component groups corresponding to a same scenario running node may be configured in a manner of separately setting priorities for the different component groups corresponding to the same scenario running node. Based on the priorities corresponding to the component groups, the first components corresponding to the same component group may be loaded adjacently. For example, for a component 3 and a component 4 that correspond to a same component group, loading of the component 4 may be triggered after the component 3 is loaded, and no other first component is loaded between the component 3 and the component 4.

For the loading sequence between the different first components corresponding to the same component group, configuration may be performed in the component configuration information. Specifically, priorities are separately set in the component configuration information for the different first components corresponding to the same component group.

Because loading time of the first components corresponding to the same component group differs little, the component group corresponding to the first component may be determined based on the rendering occasion feature of the first component. Optionally, the same component group corresponding to the different first components that need to be rendered in a same frame can be used, so that the different first components that need to be rendered in the same frame can be displayed on a page at the same time for vision of a user, thereby improving user experience.

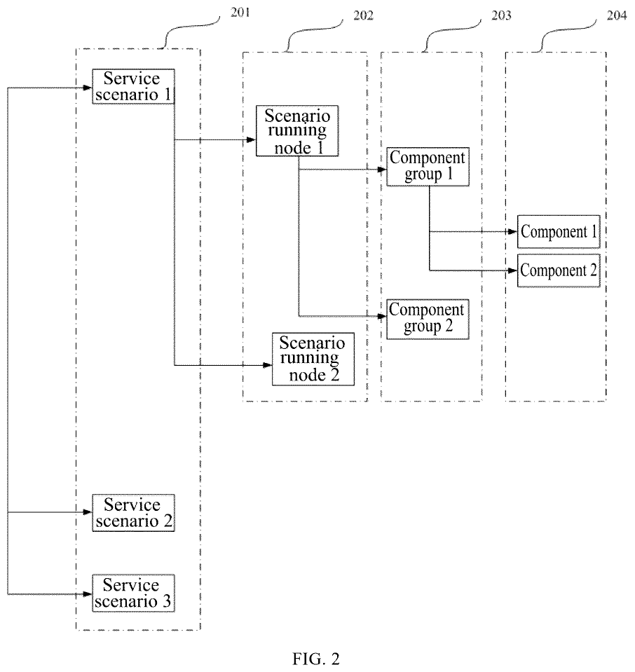

An embodiment of the present disclosure provides a schematic diagram illustrating a storage structure of a component configuration file. As illustrating in FIG. 2, the component configuration file is divided into a four-level structure, and a first-level structure 201 corresponds to service scenarios, for example, a service scenario 1 and a service scenario 2. Each service scenario can also be divided into scenario operation occasions, which correspond to a second-level structure 202, such as a scenario operation occasion 1 and a scenario operation occasion 2 in the service scenario 1. In addition, the scenario operation occasion corresponds to one or more component groups, such as a component group 1 and a component group 2 in the scenario operation occasion 1, and the component groups correspond to a third-level structure 203. The component group corresponds to one or more first components, for example, the component group 1 corresponds to a component 1 and a component 2, and the first components correspond to a fourth-level structure 204. Based on the foregoing storage structure, configuration of a component loading sequence in different service scenarios may be implemented by using the component configuration file of the four-level structure.

In addition, a priority attribute may be separately set for the component group corresponding to the third-level structure, and a loading sequence between first components corresponding to each component group can be determined by using the priority attribute. A priority attribute may also be separately set for the component corresponding to the fourth-level structure, and a loading sequence between different first components corresponding to a same component group can be determined by using the priority attribute.

S102: Upon entering the first scenario running node in the target scenario, load the first component corresponding to a first scenario running node based on the component configuration information.

In this embodiment of the present disclosure, upon entering the first scenario running node in the target scenario, the loading sequence between first components corresponding to the first scenario running node is determined based on the component loading sequence in the component configuration information, and then the first component corresponding to the first scenario running node is loaded based on the loading sequence between the first components.

In an optional implementation, upon entering the first scenario running node in the target scenario, if a load triggering event (for example, a rendering triggering operation on a page on which the first component is located) is received for the first component corresponding to the first scenario running node, a current system performance status and/or current frame rendering time-consuming information are/is first obtained. Then, based on the current system performance status and/or the current frame rendering time-consuming information, it is determined whether a component loading occasion of the first component is currently met, and specifically, it is determined whether the first component is loaded in a current frame of the first scenario running node.

The current system performance status is used to reflect whether performance of a current system can support loading of the first component. The current frame rendering time-consuming information is used to reflect whether a duration for loading the component in the current frame exceeds a preset duration, and the preset duration may be a standard duration for rendering in the current frame.

When it is determined that the component loading occasion of the first component is currently met, the first component is loaded.

In an optional implementation, the component configuration information includes a correspondence between the first component and the scenario running node, a correspondence between the first component and the component group, a loading sequence relationship between different component groups corresponding to a same scenario running node, and a loading sequence relationship between different first components corresponding to a same component group, the loading sequence between the first components corresponding to the target scenario may be determined based on the foregoing correspondences, and then, upon entering the first scenario running node in the target scenario, the first component is loaded based on the loading sequence.

In the component loading method provided in this embodiment of the present disclosure, the correspondence between the first component and the scenario running node is configured by using the component configuration information, to implement configurable loading for the component loading sequence. Because the component loading sequence can be adjusted by updating the component configuration information, code of an application does not need to be adjusted. Therefore, the component loading method provided in this embodiment of the present disclosure facilitates adjustment of the component loading sequence and the like.

During actual application, upon entering the first scenario running node, not only the first component corresponding to the first scenario running node is loaded based on the component configuration information, but also the second component corresponding to the first scenario running node is loaded based on a component original correspondence corresponding to the target scenario and the component configuration information.

The second component is a component, in the target scenario, whose component loading sequence is not configured in component configuration information. The component original correspondence corresponding to the target scenario includes an original correspondence between individual components and the scenario running node in the target scenario.

In an optional implementation, loading the second component corresponding to the first scenario running node based on the component original correspondence corresponding to the target scenario and the component configuration information includes:
first, determining a component to be loaded that corresponds to the first scenario running node based on the component original correspondence corresponding to the target scenario; then, determining the second component corresponding to the first scenario running node based on the component to be loaded that corresponds to the first scenario running node and the first component corresponding to the target scenario; and further, loading the second component corresponding to the first scenario running node.

In an optional implementation, determining the second component corresponding to the first scenario running node based on the component to be loaded that corresponds to the first scenario running node and the first component corresponding to the target scenario includes:
determining a further component, other than the first component corresponding to the first scenario running node, in the component to be loaded that corresponds to the first scenario running node as the second component corresponding to the first scenario running node.

In an optional implementation, a priority of the loading sequence between the first components corresponding to the first scenario running node configured in the component configuration information is higher than that of the second component corresponding to the first scenario running node. In other words, upon entering the first scenario running node, the first component corresponding to the first scenario running node is preferentially loaded, and then the second component corresponding to the first scenario running node is loaded.

In another optional implementation, in the case that the first scenario running node corresponds to a plurality of second components, a loading sequence between the plurality of second components is determined based on the component loading sequence in the component original correspondence, and then the second component corresponding to the first scenario running node is loaded based on the loading sequence between the plurality of second components. That is, a component that does not belong to the component configuration information is loaded based on the component loading sequence in the component original correspondence.

In an optional implementation, component loading may be implemented by using a queue. Specifically, after the loading sequence between the first component and the second component that correspond to the first scenario running node are determined, the first component and the second component that correspond to the first scenario running node are separately written into a preset queue in sequence based on the loading sequences, and the first component and the second component that correspond to the first scenario running node are written into the preset queue and wait for loading.

During actual application, upon entering the first scenario running node in the target scenario, it is determined whether the component loading occasion is currently met. If it is determined that the component loading occasion is currently met, the first component and the second component that correspond to the first scenario running node are read and loaded from the preset queue. The first component and the second component that correspond to the first scenario running node are written into the preset queue based on the loading sequence. Therefore, based on the First-In-First-Out principle of queues, once the component loading occasion is met, the first component and the second component that correspond to the first scenario running node are read and loaded from the preset queue in the same loading sequence, to complete component loading.

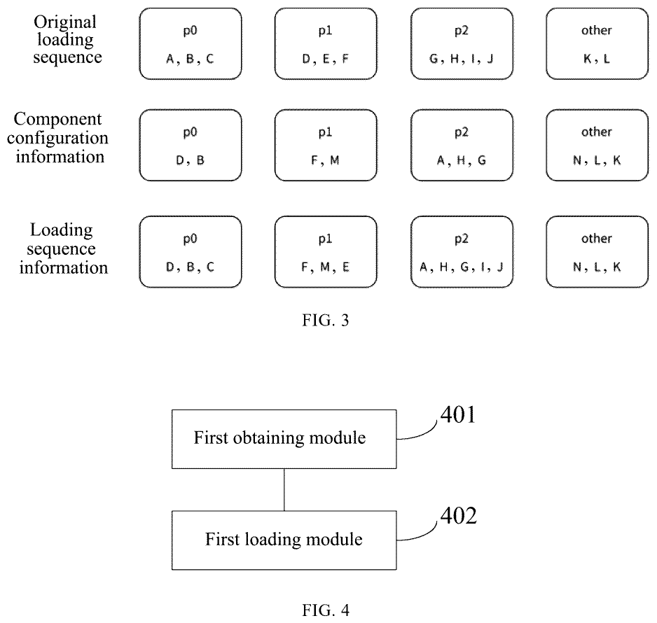

To facilitate understanding of the solution, an embodiment of the present disclosure provides a schematic diagram illustrating an effect of a component loading method, as shown in FIG. 3. The component original correspondence corresponding to the target scenario includes an original correspondence between each of components A to L and the scenario running node of the target scenario, namely, an original loading sequence between individual components.

The correspondence between the first component and the scenario running node is set in the component configuration information of the target scenario. As shown in FIG. 3, the component configuration information includes: the correspondence between a scenario running node p0 and components D and B, where the component D is loaded with priority over the component B. The correspondences between other scenario running nodes and the first components may be understood with reference to this.

In this embodiment of the present disclosure, the loading sequence information of each component is determined based on the component configuration information of the target scenario and the component original correspondence. The loading sequence information of each component may include: the correspondence between the scenario running node p0 and components B, D and C, where the component D and the component B are loaded with priority over the component C. The correspondences between other scenario running nodes and the first components may be understood with reference to this.

It should be noted that according to the component loading method based on the component configuration information provided in this embodiment of the present disclosure, the original loading sequence between components may be adjusted by adjusting the component configuration information, and the loading sequence between components (namely, the second components) that are not configured in the component configuration information remains unchanged. For example, for the component C, its original loading sequence has a correspondence with the scenario running node p0. In the redetermined loading sequence information, the component C still has a correspondence with the scenario running node p0. After the first component corresponding to the scenario running node p0 is loaded, the component C is loaded.

In the component loading method provided in this embodiment of the present disclosure, the component loading sequence is determined based on the component configuration information configured for the service scenario and the component original correspondence, and the component loading sequence in the component original correspondence may be adjusted by using the configuration component configuration information, thereby achieving configurable loading for the component loading sequence. Because the component loading sequence and the like may be adjusted by updating the component configuration information, code of an application does not need to be adjusted. Therefore, the component loading method provided in this embodiment of the present disclosure facilitates the adjustment of the component loading sequence and the like. Because the component configuration file is pulled from the configuration platform, to reduce network transmission overheads, in this embodiment of the present disclosure, a manner of updating a full-scale component configuration file by using a delta component configuration file may be used, to obtain an updated component configuration file.

Specifically, after a client stores the full-scale component configuration file, and obtains the delta component configuration file from the configuration platform, the client may update the full-scale component configuration file of the client by using the delta component configuration file. The full-scale component configuration file and the delta component configuration file may store the configuration information of the component based on a same storage structure, and the storage structure may be the foregoing storage structure of the four-level structure shown in FIG. 2.

In an optional implementation, in the delta component configuration file, editing operation information may be set for the first component that needs to be updated, and when the full-scale component configuration file is updated by using the delta component configuration file, an editing operation may be performed on the configuration information of the target component in the full-scale component configuration file based on the editing operation information of the target component in the delta component configuration file. For example, the editing operation information may include an addition operation, a deletion operation, a modification operation, and the like that are for the target component.

In an optional implementation, an operator may be added to the first component that needs to be updated in the delta component configuration file, or an operator may be added to the component group that needs to be updated in the delta component configuration file, or an operator or the like may be added to the service scenario that needs to be updated in the delta component configuration file. Specifically, the operator is used to identify editing operation information for a target editing object. The target editing object may include the first component, the component group, the service scenario, or the like in the full-scale component configuration file.

The operator may include one of adding (“add”), removing (“remove”), replacing (“replace”), clearing (“clear”), and modifying (“modify”). “Add” is used to indicate that the delta component configuration file and the full-scale component configuration file are accumulated for the target editing object, and the configuration information for the target editing object in the delta component configuration file is inserted into the full-scale component configuration file. “Remove” is used to indicate that the configuration information for the target editing object in the full-scale component configuration file is removed. “Replace” is used to indicate that the configuration information for the target editing object in the full-scale component configuration file is replaced with the configuration information for the target editing object in the delta component configuration file. “Clear” is used to indicate that the configuration information for the target editing object in the full-scale component configuration file is deleted. “Modify” is used to indicate that the configuration information of the target editing object in the full-scale component configuration file is modified.

In an embodiment of the present disclosure, after the full-scale component configuration file is updated by using the delta component configuration file, to obtain the updated component configuration file, the components corresponding to each service scenario may be loaded based on the updated component configuration file.

Based on the foregoing method embodiment, the present disclosure further provides a component loading apparatus. FIG. 4 is a schematic structural diagram illustrating a component loading apparatus according to an embodiment of the present disclosure. The apparatus includes:
a first obtaining module 401 configured to obtain component configuration information corresponding to a target scenario in response to a component loading request for the target scenario, where the component configuration information includes a correspondence between a first component and a scenario running node in the target scenario, the scenario running node is obtained by dividing a life cycle of the target scenario, and different scenario running nodes have an execution sequence relationship; and
a first loading module 402 configured to, upon entering the first scenario running node in the target scenario, load the first component corresponding to a first scenario running node based on the component configuration information.

In an optional implementation, the apparatus further includes:
a second loading module configured to, upon entering the first scenario running node, load a second component corresponding to the first scenario running node based on a component original correspondence corresponding to the target scenario and the component configuration information.

In an optional implementation, the second loading module includes:
a first determining sub-module configured to determine a component to be loaded that corresponds to the first scenario running node based on the component original correspondence corresponding to the target scenario;
a second determining sub-module configured to determine the second component corresponding to the first scenario running node based on the component to be loaded that corresponds to the first scenario running node and the first component corresponding to the target scenario; and
a first loading sub-module configured to load the second component corresponding to the first scenario running node.

In an optional implementation, the first loading sub-module includes:
a third determining sub-module configured to: in the case that the first scenario running node corresponds to a plurality of second components, determine a loading sequence between the plurality of second components based on a component loading sequence in the component original correspondence; and
a second loading sub-module configured to load the second component corresponding to the first scenario running node based on the loading sequence between the plurality of second components.

In an optional implementation, the first loading module includes:
a fourth determining sub-module configured to determine a loading sequence between first components based on a component loading sequence in the component configuration information; and
a third loading sub-module configured to load the first component corresponding to the first scenario running node based on the loading sequence between the first components.

In an optional implementation, a priority of the loading sequence between the first components corresponding to the first scenario running node is higher than that of the second component corresponding to the first scenario running node.

In an optional implementation, the apparatus further includes:
a writing module configured to separately write, in sequence based on a loading sequence between the first component and the second component that correspond to the first scenario running node, the first component and the second component that correspond to the first scenario running node into a preset queue separately, where the preset queue is used to load the first component and the second component.

In an optional implementation, the first loading module includes:
a fifth determining sub-module configured to: upon entering the first scenario running node in the target scenario, determine whether a component loading occasion is currently met; and
a reading sub-module configured to: when determining that the component loading occasion is currently met, read and load, from the preset queue, the first component corresponding to the first scenario running node.

In an optional implementation, the component configuration information further includes a correspondence between the first component and a component group, a loading sequence between different component groups corresponding to a same scenario running node, and a loading sequence between different first components corresponding to a same component group, and the correspondence between the first component and the component group is determined based on a rendering occasion feature of the first component; and the first loading module includes:
a sixth determining sub-module configured to: upon entering the first scenario running node in the target scenario, determine a component group corresponding to the first scenario running node based on the component configuration information; and
a fourth loading sub-module configured to load a first component corresponding to the component group.

In an optional implementation, the apparatus further includes:
a second obtaining module configured to obtain a delta component configuration file from a configuration platform; and
an updating module configured to update a full-scale component configuration file by using the delta component configuration file, to obtain an updated component configuration file, where the updated component configuration file includes the component configuration information corresponding to the target scenario.

In an optional implementation, the delta component configuration file includes editing operation information for a target component, and the updating module includes:
an editing sub-module configured to perform an editing operation on configuration information of the target component in the full-scale component configuration file based on the editing operation information for the target component, to obtain updated configuration information of the target component; and
a seventh determining sub-module configured to determine an updated component configuration file based on the updated configuration information of the target component.

In the component loading apparatus provided in the embodiments of the present disclosure, when the component loading request for the target scenario is received, the component configuration information corresponding to the target scenario is first obtained. The component configuration information includes the correspondence between the first component and the scenario running node that correspond to the target scenario, and different scenario running nodes have an execution sequence relationship. Upon entering after the first scenario running node in the target service scenario, the first component corresponding to the first scenario running node is loaded based on the component configuration information. In the embodiments of the present disclosure, the correspondence between the first component and the scenario running node can be configured by using the component configuration information, to realize configurable loading for the component loading sequence. Because the component loading sequence can be adjusted by updating the component configuration information, code of an application does not need to be adjusted. Therefore, the component loading method provided in the embodiments of the present disclosure facilitates adjustment of the component loading sequence and the like.

In addition to the method and apparatus described above, an embodiment of the present disclosure further provides a computer-readable storage medium having instructions stored therein. The instructions, when executed on a terminal device, cause the terminal device to implement the component loading methods described in the embodiments of the present disclosure.

An embodiment of the present disclosure further provides a computer program product. The computer program product includes a computer program or instructions. The computer program or instructions, when executed by a processor, cause the component loading methods described in the embodiments of the present disclosure to be implemented.

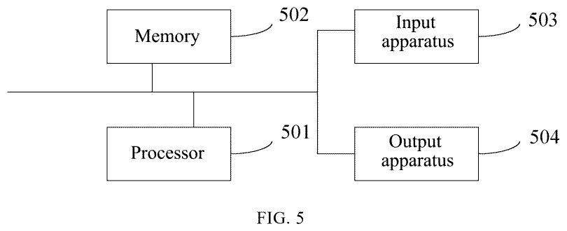

In addition, an embodiment of the present disclosure further provides a component loading device. As shown in FIG. 5, the device may include:
a processor 501, a memory 502, an input apparatus 503, and an output apparatus 504. There may be one or more processors 501 in the component loading device. For example, there is one processor in FIG. 5. In some embodiments of the present disclosure, the processor 501, the memory 502, the input apparatus 503, and the output apparatus 504 may be connected through a bus or in another manner, for example, are connected through the bus in FIG. 5.

The memory 502 may be configured to store a software program and a module. The processor 501 performs various functional applications of the component loading device and processes data by running the software program and the module stored in the memory 502. The memory 502 may mainly include a program storage area and a data storage area. The program storage area may store an operating system, an application required by at least one function, and the like. In addition, the memory 502 may include a high-speed random-access memory, and may further include a non-volatile memory, for example, at least one magnetic disk storage device, a flash memory device, or another volatile solid-state storage device. The input apparatus 503 may be configured to receive entered numerical or character information, and generate a signal input related to a user setting and function control of the component loading device.

Specifically, in this embodiment, the processor 501 loads an executable file corresponding to a process of one or more applications into the memory 502 according to the following instructions, and the processor 501 runs the application stored in the memory 502, to implement various functions of the foregoing component loading device.

It should be noted that the relational terms such as “first” and “second” herein are only used to distinguish one entity or operation from another, and do not necessarily require or imply that any actual relationship or sequence exists between these entities or operations. Moreover, the terms “include” and “comprise”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including/comprising a/an . . . ” does not exclude another identical element in a process, method, article, or device that includes the element.

The foregoing description illustrates merely specific implementations of the present disclosure, so that those skilled in the art can understand or implement the present disclosure. Various modifications to these embodiments are apparent to those skilled in the art, and the general principle defined herein may be practiced in other embodiments without departing from the spirit or scope of the present disclosure. Therefore, the present disclosure will not be limited to the embodiments described herein, but extends to the widest scope that complies with the principles and novelty disclosed in this specification.

1. A component loading method, comprises:
obtaining component configuration information corresponding to a target scenario in response to a component loading request for the target scenario, wherein the component configuration information comprises a correspondence between a first component and a scenario running node in the target scenario, the scenario running node is obtained by dividing a life cycle of the target scenario, and different scenario running nodes have an execution sequence relationship; and
upon entering the first scenario running node in the target scenario, loading the first component corresponding to a first scenario running node based on the component configuration information.

2. The method of claim 1, wherein upon entering the first scenario running node, the method further comprises:
loading a second component corresponding to the first scenario running node based on a component original correspondence corresponding to the target scenario and the component configuration information.

3. The method of claim 2, wherein loading the second component corresponding to the first scenario running node based on the component original correspondence corresponding to the target scenario and the component configuration information comprises:
determining a component to be loaded that corresponds to the first scenario running node based on the component original correspondence corresponding to the target scenario;
determining the second component corresponding to the first scenario running node based on the component to be loaded that corresponds to the first scenario running node and the first component corresponding to the target scenario; and
loading the second component corresponding to the first scenario running node.

4. The method of claim 3, wherein loading the second component corresponding to the first scenario running node comprises:
determining, in response to the first scenario running node corresponding to a plurality of second components, a loading sequence between the plurality of second components based on a component loading sequence in the component original correspondence; and
loading the second component corresponding to the first scenario running node based on the loading sequence between the plurality of second components.

5. The method of claim 1, wherein loading the first component corresponding to a first scenario running node based on the component configuration information comprises:
determining a loading sequence between first components based on a component loading sequence in the component configuration information; and
loading the first component corresponding to the first scenario running node based on the loading sequence between the first components.

6. The method of claim 2, wherein
a priority of loading the first component corresponding to the first scenario running node is higher than a priority of the second component corresponding to the first scenario running node.

7. The method of claim 2, wherein the method further comprises:
writing, in sequence based on a loading sequence between the first component and the second component that correspond to the first scenario running node, the first component and the second component that correspond to the first scenario running node into a preset queue sequentially, wherein the preset queue is used to load the first component and the second component.

8. The method of claim 7, wherein upon entering the first scenario running node in the target scenario, loading the first component corresponding to the first scenario running node based on the component configuration information comprises:
upon entering the first scenario running node in the target scenario, determining whether a component loading occasion is currently met; and
in response to determining that the component loading occasion is currently met, reading and loading, from the preset queue, the first component corresponding to the first scenario running node.

9. The method of claim 1, wherein the component configuration information further comprises a correspondence between the first component and a component group, a loading sequence between different component groups corresponding to a same scenario running node, and a loading sequence between different first components corresponding to a same component group, and the correspondence between the first component and the component group is determined based on a rendering occasion feature of the first component; and upon entering the first scenario running node in the target scenario, loading the first component corresponding to a first scenario running node based on the component configuration information comprises:
upon entering the first scenario running node in the target scenario, determining a component group corresponding to the first scenario running node based on the component configuration information; and
loading a first component corresponding to the component group.

10. The method of claim 1, wherein before obtaining the component configuration information corresponding to the target scenario in response to the component loading request for the target scenario, the method further comprises:
obtaining a delta component configuration file from a configuration platform; and
updating a full-scale component configuration file by using the delta component configuration file, to obtain an updated component configuration file, wherein the updated component configuration file comprises the component configuration information corresponding to the target scenario.

11. The method of claim 10, wherein the delta component configuration file comprises editing operation information for a target component, and updating the full-scale component configuration file by using the delta component configuration file, to obtain the updated component configuration file comprises:
performing an editing operation on configuration information of the target component in the full-scale component configuration file based on the editing operation information for the target component, to obtain updated configuration information of the target component; and
determining an updated component configuration file based on the updated configuration information of the target component.

12. (canceled)

13. A non-transitory computer-readable storage medium having instructions stored therein, wherein the instructions, when executed on a terminal device, cause the terminal device to:
obtain component configuration information corresponding to a target scenario in response to a component loading request for the target scenario, wherein the component configuration information comprises a correspondence between a first component and a scenario running node in the target scenario, the scenario running node is obtained by dividing a life cycle of the target scenario, and different scenario running nodes have an execution sequence relationship; and
upon entering the first scenario running node in the target scenario, load the first component corresponding to a first scenario running node based on the component configuration information.

14. A component loading device, comprising: a memory, a processor, and a computer program that is stored in the memory and that is executable on the processor, wherein the computer program, when executed by the processor, causes the processor to:
obtain component configuration information corresponding to a target scenario in response to a component loading request for the target scenario, wherein the component configuration information comprises a correspondence between a first component and a scenario running node in the target scenario, the scenario running node is obtained by dividing a life cycle of the target scenario, and different scenario running nodes have an execution sequence relationship; and
upon entering the first scenario running node in the target scenario, load the first component corresponding to a first scenario running node based on the component configuration information.

15. The non-transitory computer-readable storage medium of claim 13, wherein upon entering the first scenario running node, the instructions further cause the terminal device to:
load a second component corresponding to the first scenario running node based on a component original correspondence corresponding to the target scenario and the component configuration information.

16. The non-transitory computer-readable storage medium of claim 15, wherein the instructions configured to load the second component corresponding to the first scenario running node based on the component original correspondence corresponding to the target scenario and the component configuration information further causes the terminal device to:
determine a component to be loaded that corresponds to the first scenario running node based on the component original correspondence corresponding to the target scenario;
determine the second component corresponding to the first scenario running node based on the component to be loaded that corresponds to the first scenario running node and the first component corresponding to the target scenario; and
load the second component corresponding to the first scenario running node.

17. The non-transitory computer-readable storage medium of claim 16, wherein the instructions configured to load the second component corresponding to the first scenario running node further causes the terminal device to:
determine, in response to the first scenario running node corresponding to a plurality of second components, a loading sequence between the plurality of second components based on a component loading sequence in the component original correspondence; and
load the second component corresponding to the first scenario running node based on the loading sequence between the plurality of second components.

18. The component loading device of claim 14, wherein the computer program configured to load the first component corresponding to a first scenario running node based on the component configuration information further causes the processor to:
determining a loading sequence between first components based on a component loading sequence in the component configuration information; and
loading the first component corresponding to the first scenario running node based on the loading sequence between the first components.

19. The component loading device of claim 18, wherein
a priority of loading the first component corresponding to the first scenario running node is higher than a priority of the second component corresponding to the first scenario running node.

20. The component loading device of claim 14, wherein before obtaining the component configuration information corresponding to the target scenario in response to the component loading request for the target scenario, the computer program further causes the processor to:
obtain a delta component configuration file from a configuration platform; and
update a full-scale component configuration file by using the delta component configuration file, to obtain an updated component configuration file, wherein the updated component configuration file comprises the component configuration information corresponding to the target scenario.

21. The component loading device of claim 20, wherein the delta component configuration file comprises editing operation information for a target component, and the computer program configured to update the full-scale component configuration file by using the delta component configuration file, to obtain the updated component configuration file further causes the processor to:
perform an editing operation on configuration information of the target component in the full-scale component configuration file based on the editing operation information for the target component, to obtain updated configuration information of the target component; and
determine an updated component configuration file based on the updated configuration information of the target component.
